(19) United States
(12) Patent Application Publication
(10) Pub. No.: US 2020/0316553 A1
(43) Pub. Date: Oct. 8, 2020

(54) REACTION CELL FOR ASYNCRONOUS MULTIPLE PEPTIDE INSTRUMENT

(71) Applicant: Creosalus INC, Louisville, KY (US)

(72) Inventor: Vasiliy Abramov, Louisville, KY (US)

(73) Assignee: Creosalus INC, Louisville, KY (US)

(21) Appl. No.: 16/908,874

(22) Filed: Jun. 23, 2020

Related U.S. Application Data
(63) Continuation-in-part of application No. 16/299,954, filed on Mar. 12, 2019.
Application No. 16/299,954 is a continuation of application No. 15/409,048, filed on Jan. 18, 2017, now abandoned.

(51) Int. Cl. B01J 19/00

(52) U.S. Cl. CPC B01J 19/0046; B01J 2219/00725; B01J 2219/00585; B01J 2219/00337; B01J 2219/00596; B01J 2219/00283; B01J 2219/0059

(57) ABSTRACT

A reaction cell for an automated peptide synthesizer consists of a body having a first reaction well in fluid communication with a second reaction well for simultaneous reactions. The first reaction well can be used for reagent pre-activation simultaneously with an amino acid addition in the second reaction well. When the addition reaction is complete and after a washing step the activated reagent is automatically transferred to the second reaction well for the next addition reaction without the necessity of a separate transfer step.

### FIELD OF THE INVENTION

This invention relates to the synthesis of peptides and more particularly to automated peptide synthesis instruments.

### BACKGROUND OF THE INVENTION

In the synthesis of peptides by solid state peptide synthesis (SPPS) automated peptide synthesis instruments provide substantial labor and time savings in the solid-state synthesis of peptides. There are a variety of peptide instruments in the prior art, however, of particular interest is the TETRAS™ asynchronous multi-margins peptide instrument distributed by Advanced Chemtech, Louisville, Ky. This instrument, described in patent publication 20070140925, comprises a carousel carrying a plurality of individual reaction cells for moving the cells between injection stations containing reagents and ancillary solvents for delivery to the reaction cells. The instrument further includes purge stations for removing liquids from the reaction cells upon completion of a synthesis step. The instrument is programmable to produce a variety of peptides.

### SUMMARY OF THE INVENTION

The present invention is desired for use in automated chemical synthesizers for solid state peptide synthesis. Depending on the peptide being synthesized, there may be an activation step to activate the particular reagents for the next reaction. As pointed out above for purposes of description the invention will be described in connection with the TETRAS™ peptide synthesizer although, with modifications to the instrument, the reaction cell can be employed on other types of automated instruments.

With conventional reaction cells for the TETRAS™ the reaction cell containing resin beads is moved into alignment with an injection station containing the activation reagent and peptide or peptide chin to be added to the solid substrate. Activation includes protecting the N-terminous with a suitable agent such as Boc (acid-labile) or Fmoc (base labile). Following the activation step the cell is moved to an injection station for deprotection of the attached amino building block and for washing to remove reaction by-products and to coupling the next protected amino acid as described above according to the selected protocol. In other types of peptide synthesizers, the reagents may be brought to the reaction cell rather than moving the reaction cell to stationary injection stations.

The efficiency of the solid-state peptide synthesis is improved and time saved by the present invention comprising an improved dual well reaction cell in which activation of reagents and the reaction resulting in the addition of an amino acid to a reaction product on the substrate are carried out essentially simultaneously.

In accordance with the invention a novel reaction cell is provided that comprises separate reaction wells that are in one-way fluid communication. In this manner a reaction step can be carried out simultaneously with an activation step so as to essentially combine two steps of a synthesis in a single cell. Both the activation step and the reaction step may require some time in which to complete the steps. By carrying out both steps at essentially the same time the efficiency of the instrument is improved.

### DESCRIPTION OF THE DRAWINGS

FIG. 1 is a perspective view of the reaction cell of the invention;

FIG. 2 is a broken away perspective view of the reaction cell of FIG. 1;

FIG. 3 is a bottom plan view of the reaction cell of FIG. 1;

FIG. 4 is a side sectional view of the reaction cell of FIG. 3 viewed through line A-A;

FIG. 5 is a side sectional view of the reaction cell of FIG. 3 viewed through line B-B;

### DESCRIPTION OF THE INVENTION

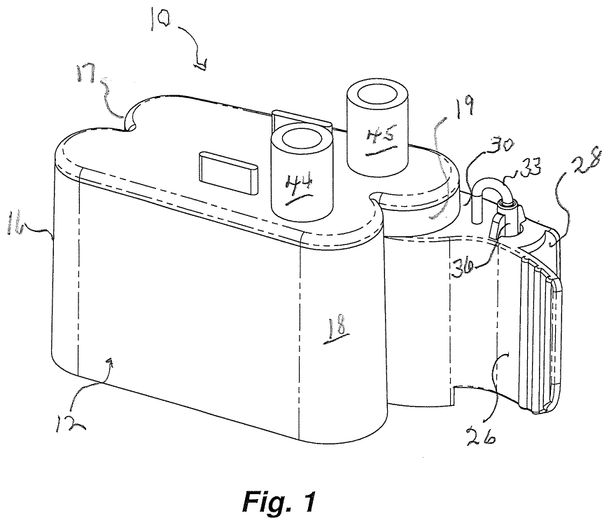

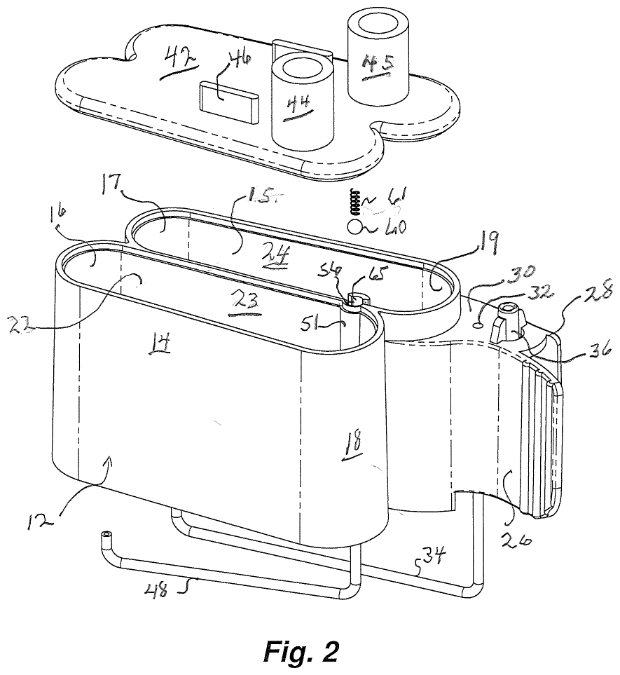

FIG. 1 and FIG. 2 illustrate a reaction cell shown generally as 10 comprising a body 12 having an interior defined by opposed sidewalls 14 and 15, end walls 16, 17, 18 and 19 and bottom walls 20 and 21. A common wall 22 extends through the interior between said end walls 16 and 17 and said end walls 18 and 19 to form a first reaction well 23 comprising side wall 14, end walls 16 and 18, bottom wall 20 and common wall 22. A second adjacent reaction well 24 is formed comprising side wall 15, end walls 17 and 19, bottom wall 21 and common wall 22. In a preferred embodiment for producing a peptide by solid state synthesis the well 23 is used for pre-activation of reagents and well 24 for the solid state peptide building block addition.

The end wall 19 and side wall 15 of the well 24 are extended to form opposed spaced apart members 26 and 28 respectively and a transverse member 30 including a port 32 and fluid discharge connector body 36 extends between the extensions 26 and 28. A discharge line 34 communicates from the well 24 through a port 54 formed in the bottom wall 21 of the well 24 to the port 32. A u-shaped connector tube 33 provides fluid communication between the port 32 and the fluid discharge body 36 for discharge of reaction fluids upon completion of the peptide addition reaction.

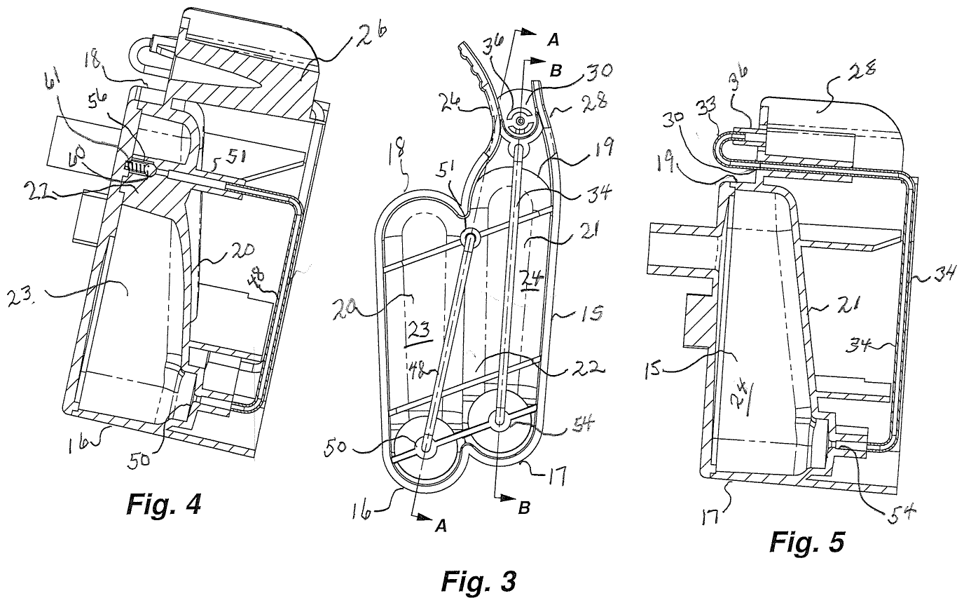

As shown in FIG. 2, FIG. 3 and FIG. 4 a through-running tubular passage 51 is formed on the common wall 22. The tubular passage extends vertically and opens at the upper and lower edges of the common wall. A port 50 is provided in the bottom wall 20 of the well 23. A fluid transfer line 48 extends from the port 50 in the well 23 to the tubular passage 51 in the common wall 22 for fluid communication with the interior of the well 24 for transfer of activated reagent from the well 23 to the well 24. A check valve 56 comprising a valve body 60 and spring provides one-way fluid flow from well 23 to well 24. A portion of the valve body 38 is cut away at 65 to permit fluid discharge into the well 24.

The wells 23 and 24 are closed by a lid 42 having ports 44 and 45 for introduction of reagents to the wells. Vertically extending members 46 on the lid 42 serve as grips for handling the lid.

The reaction cell of the invention is designed for use with an automated peptide synthesizer such as the TETRAS® asynchronous peptide synthesizer for synthesis of peptides by solid state technology. This methodology includes the addition of individual or small chains of amino acids to amino acids retained on a solid base to build up a peptide chain of desired composition and length. In order to prepare the amino acid for attachment to the chain the amino acid must first be activated for attachment. Both the activation step and the attachment step can be time consuming. Efficiency of the automated synthesizer can be greatly increased if activation and addition reactions can be carried out simultaneously and in the same reaction cell.

In operation the reaction well 23 of cell 10 is charged with reagent including the amino acid or acids to be activated and a suitable protecting agent to prepare (activate) the amino acid building blocks for attachment directly to resin beads or an previously attached building block for building the desired peptide. Simultaneously, well 24 includes the solid substrate on to which the amino acid is to be attached. Introduction of a suitable gas, such as air or nitrogen, to the well 23 through the port 44 creates a positive pressure to force the liquid in the well through the port 50, transfer line 48 and tubular passage 51 into the well 24. Both the activation step and the addition step are carried out simultaneously. On completion of the attachment reaction as sensed by the synthesizer, either by elapsed time or sampling reaction by-products, the reaction cell is moved to a washing station and reaction by-products are removed by the introduction of a suitable gas, such as air or nitrogen, to the well 24 through the port 45 to create a positive pressure to force the liquid in the well 24 through the port 54 and discharge line 34 for discharge through the u-shaped tube 33 and the fluid discharge body 36. The solid phase including the attached peptides remains in the well 24 awaiting the next batch of activated amino acid for attachment.

The check valve 56 prevents back flow of the of the activated reagent. Upon completion of the reaction in the second well 24, activated reagent is transferred from the first reaction well 23 to the second reaction well 24 to add new amino acid moieties in forming the desired peptide. The well 23 is moved to a washing station and thoroughly washed to remove the residue of the activating reagent before being recharged with reagent and amino acid building block for activation of the amino acid moiety. In this manner a reagent can be activated in the first reaction well 23 while solid state peptide reactions are occurring in the second reaction well 24. This results in a substantial saving of time and improves the efficiency of a peptide synthesis.

1. A reaction cell for an automated peptide synthesizer, said reaction well comprising:
a body comprising opposed sidewalls 14 and 15, end walls 16, 17, 18 and 19 and bottom walls 20 and 21 to define an interior,
a common wall 22 extends through the interior between said end walls 16 and 17 and said end walls 18 and 19 to form a first reaction well 23 comprising side wall 14, end walls 16 and 18, bottom wall 20 and common wall 22 and a second adjacent reaction well 24 comprising side wall 15, end walls 17 and 19, bottom wall 21 and common wall 22,
a port 50 in said bottom wall 20 of said reaction well 23 opens to the exterior of said bottom wall and a port 54 in said bottom wall 21 of said reaction well 24 opens to the exterior of said bottom wall,
said end wall 19 and said side wall 15 are extended to form opposed spaced apart members 26 and 28,
a transverse member 30 extends between said members 26 and 28, said transverse member having a port 30 opening to the exterior of said transverse member and a fluid discharge connector body 36
a discharge line 34 communicates from said reaction well 24 through said port 54 to said port 32 and a u-shaped connector tube 33 provides fluid communication between the port 32 and the fluid discharge body 36 for discharge of reaction fluids from said reaction well 24 upon completion of the peptide addition reaction,
a through-running tubular passage 51 including a check valve 56 is formed in said common wall 22,
a fluid transfer line 48 extends from said port 50 in the well 23 to said tubular passage 51 for fluid communication with said well 24 for transfer of activated reagent from the well 23 to the well 24,
whereby two different chemical reactions can be simultaneously carried out in said first and said second reaction wells and the product of the chemical reaction in said first reaction well can be transferred to said second reaction well for subsequent chemical reaction.
